(19) United States
(12) Patent Application Publication
(10) Pub. No.: US 2010/0299276 A1
(43) Pub. Date: Nov. 25, 2010

(54) INVITATIONS WITH PRE-POPULATED PROFILE INFORMATION

(75) Inventors: Omar Shahine, Menlo Park, CA (US); Joseph Andrew Bono, Kirkland, WA (US); Paul Alan Elliott, Woodinville, WA (US); Ann Marie Hudspeth, Redmond, WA (US); Michelle Marise Aleong, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/470,504

(22) Filed: May 22, 2009

(51) Int. Cl. G06Q 99/00

(52) U.S. Cl. 705/319; 715/764

(57) ABSTRACT

Tools and techniques related to invitations with pre-populated profile information are provided. These tools may receive requests to create invitations for invitee users to join social networks, populate these invitations with profile information on behalf of at least one inviter user, and send these invitations to the invitee users.

### BACKGROUND

Social networks continue to proliferate, gaining members around the world. Typically, a given member of a social network may invite friends or acquaintances to join that social network. A given member of a social network may his or her complete profile information, with this profile information providing various contact, personal, or other information related to that given member.

### SUMMARY

Tools and techniques related to invitations with pre-populated profile information are provided. These tools may receive requests to create invitations for invitee users to join social networks, populate these invitations with profile information on behalf of at least one inviter user, and send these invitations to the invitee users.

It should be appreciated that the above-described subject matter may be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a combined block and flow diagram illustrating systems or operating environments related to sending and receiving invitations with pre-populated profile information.

FIG. 2 is a block diagram illustrating data structures or hierarchies that may be suitable for implementing user profiles.

FIG. 3 is a flow diagram illustrating processes for sending and receiving invitations with pre-populated profile information.

FIG. 4 is a block diagram illustrating user interfaces (UIs) that may enable inviter user devices to create and send invitations with pre-populated profile information.

FIG. 5 is a block diagram illustrating user interfaces that may be presented by the invitee user devices to display invitations to join social networks.

FIG. 6 is a block diagram illustrating user interfaces that the invitee user devices may present to enable invitee users to act on the invitations to join social networks.

### DETAILED DESCRIPTION

The following detailed description provides tools and techniques for invitations with pre-populated profile information. While the subject matter described herein presents a general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

The following detailed description refers to the accompanying drawings that form a part hereof, and that show, by way of illustration, specific example implementations. Referring now to the drawings, in which like numerals represent like elements through the several figures, this description provides various tools and techniques related to social network invitations with pre-populated profile information.

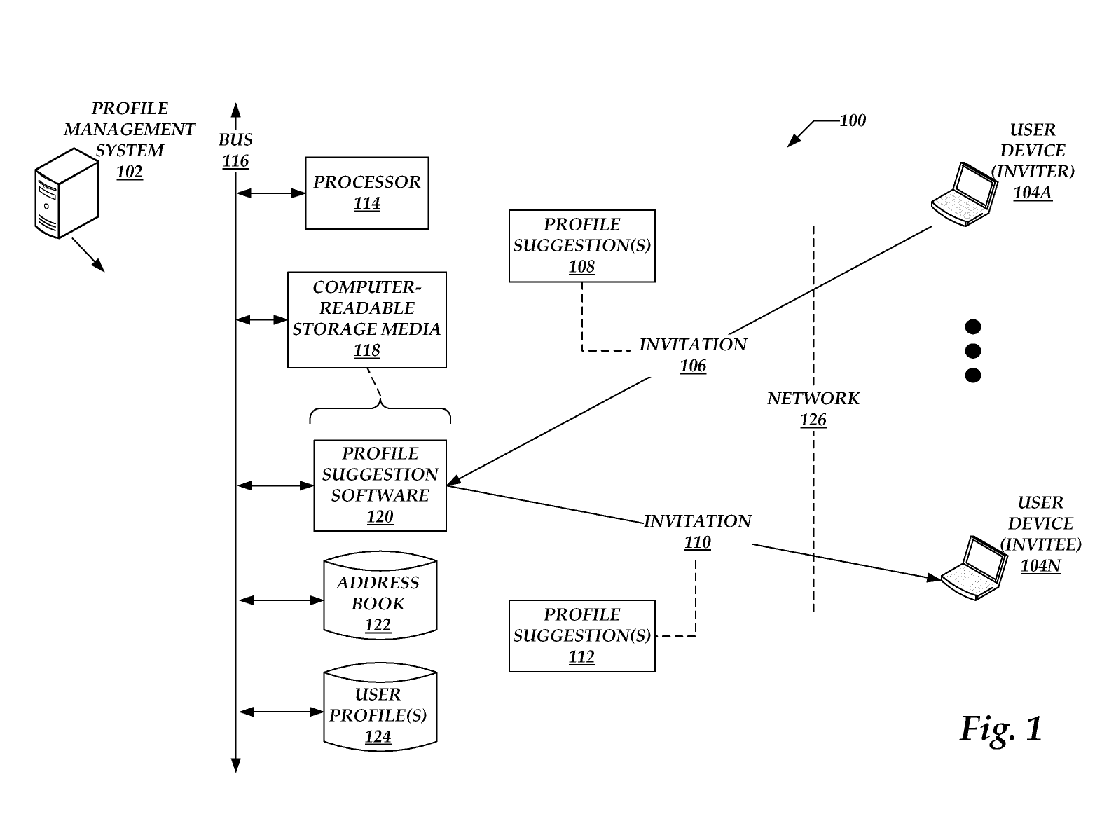

FIG. 1 illustrates systems or operating environments, denoted generally at 100, related to social network invitations with pre-populated profile information. Turning to FIG. 1 in more detail, these systems 100 may include any number of profile management systems or servers 102. Although FIG. 1 illustrates one example of the file management system 102, implementations of this description may include any number of profile management systems 102.

Only for the purposes of illustration, this description discusses examples in which the profile management systems 102 operate in connection with one or more social networking systems. However, it is understood that this description may be implemented more generally. For example, implementations of this description may operate in any system that supports some number of different users, with different users associated with respective profile information. As described in further detail below, these profile management systems may enable a given user to send invitations to other users, with these invitations pre-populated with profile information or those other users.

As shown in FIG. 1, these systems or operating environments 100 may also include any number of user devices 104a and 104n (collectively, user devices 104). In general, the profile management systems 102 and the user device 104a may cooperate to pre-populate an invitation 106 with profile suggestions 108, and to send that invitation 106 to the user device 104n. FIG. 1 denotes at 110 the invitation 106 as sent to the user device 104n, and denotes at 112 the pre-populated profile suggestions 108 as incorporated into the invitation 110.

For the purposes of describing these example operational scenarios, FIG. 1 denotes the user device 104a as an “inviter” device. More specifically, this “inviter” device 104a may operate in response to a given user who is inviting one or more other users to join a social network that is facilitated by the profile management system 102. These other users may be associated with the representative user device 104n, and these other users may be considered invitees of this given user. Accordingly, FIG. 1 denotes the user device 104n as an “invitee” device.

Turning to the file management systems 102 and the user devices 104 in more detail, these devices may include one or more instances of processing hardware, with FIG. 1 providing a representative processor 114 as an example of such processing hardware. The processors 114 may have a particular type or architecture, chosen as appropriate for particular implementations of the profile management system 102 and/or the user devices 104. In addition, the processors 114 may couple to one or more bus systems 116, having type and/or architecture that is chosen for compatibility with the processors 114.

The profile management systems 102 and/or the user devices 104 may include one or more instances of a physical computer-readable storage medium or media 118, which couple to the bus systems 116. The bus systems 116 may enable the processors 114 to read code and/or data to/from the computer-readable storage media 118. The media 118 may represent apparatus in the form of storage elements that are implemented using any suitable technology, including but not limited to semiconductors, magnetic materials, optics, or the like. The media 118 may represent memory components, whether characterized as RAM, ROM, flash, solid-state hard drive, or other types of technology.

The storage media 118 may include one or more modules of software instructions that, when loaded into the processors 114 and executed, cause the profile management systems 102 and/or the user devices 104 to execute software in connection with providing social network invitations with pre-populated profile information. As detailed throughout this description, these modules of instructions may also provide various tools or techniques by which the profile management systems 102 and/or the user devices 104 may participate within the overall systems or operating environments described herein using the components, message and command flows, and data structures discussed in more detail throughout this description. For example, the storage media 118 may contain profile suggestion software modules, denoted generally at 120. The profile suggestion software 120 may include software instructions that are configured to perform the functions described herein in connection with providing social network invitations with pre-populated profile information.

In general, the profile suggestion software 120 may, when loaded into the processors 114 and executed, transform the processors 114 (and the overall profile management systems 102 and/or the user devices 104) from general-purpose computing systems into special-purpose computing systems customized to present integrated advertising content. The processors 114 may be constructed from any number of transistors or other discrete circuit elements, which may individually or collectively assume any number of states. More specifically, the processors 114 may operate as finite-state machines, in response to executable instructions contained within the software 120. These computer-executable instructions may transform the processors 114 by specifying how the processors 114 transition between states, thereby physically transforming the transistors or other discrete hardware elements constituting the processors 114.

Encoding the file suggestion software 120 may also transform the physical structure of the storage media 118. The specific transformation of physical structure may depend on various factors, in different implementations of this description. Examples of such factors may include, but are not limited to: the technology used to implement the storage media 118, whether the storage media 118 are characterized as primary or secondary storage, and the like. For example, if the storage media 118 is implemented as semiconductor-based memory, the file suggestion software 120 may transform the physical state of the semiconductor memory, when the software is encoded therein. For example, the software may transform the states of transistors, capacitors, or other discrete circuit elements constituting the semiconductor memory.

As another example, the storage media 118 may be implemented using magnetic or optical technology. In such implementations, the profile suggestion software 120 may transform the physical state of such magnetic or optical media, when the software 120 is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope and spirit of the present description, with the foregoing examples provided only to facilitate this discussion.

The storage media 118 may include any number of storage elements that cooperate with the profile suggestion software 120 during execution. For example, an address book data structure 122 may contain contact information or other types of information associated with any number of different users. This address book structure 122 may reside physically on the profile management system 102 and/or the user devices 104. For example, a given user associated with the user device 104 may maintain an instance of the address book structure 122 to contain information related to other users (e.g., associated with one or more of a representative user devices 104n).

The storage media 118 may also include a user profile data structure 124, maintained by the profile management systems 102 and/or the user devices 104 in connection with, for example, social networks facilitated by the profile management systems 102. The user profiles 124 may include contact information, demographic information, interest information, or only other information maintained for different users. In a social network context, the user profiles 124 for different given users may include, but are not limited to, names, e-mail addresses, telephone numbers, usernames, birthdays, identification of third-party services or websites of interest to those given users, areas of interest, and the like. Other examples of information contained within the user profiles 124 may become apparent after reading this description, and are considered within the scope of this description.

As shown in FIG. 1, the profile management systems 102 may communicate with any number of user devices 104 over one or more intermediate communications networks 126. The networks 126 may generally represent global, wide-area, regional, local-area, or personal networks. In addition, the networks 126 may represent network adapters, connectors, cabling and other hardware infrastructure associated with the foregoing communications networks, as well as any drivers or software associated with communicating through the networks 126.

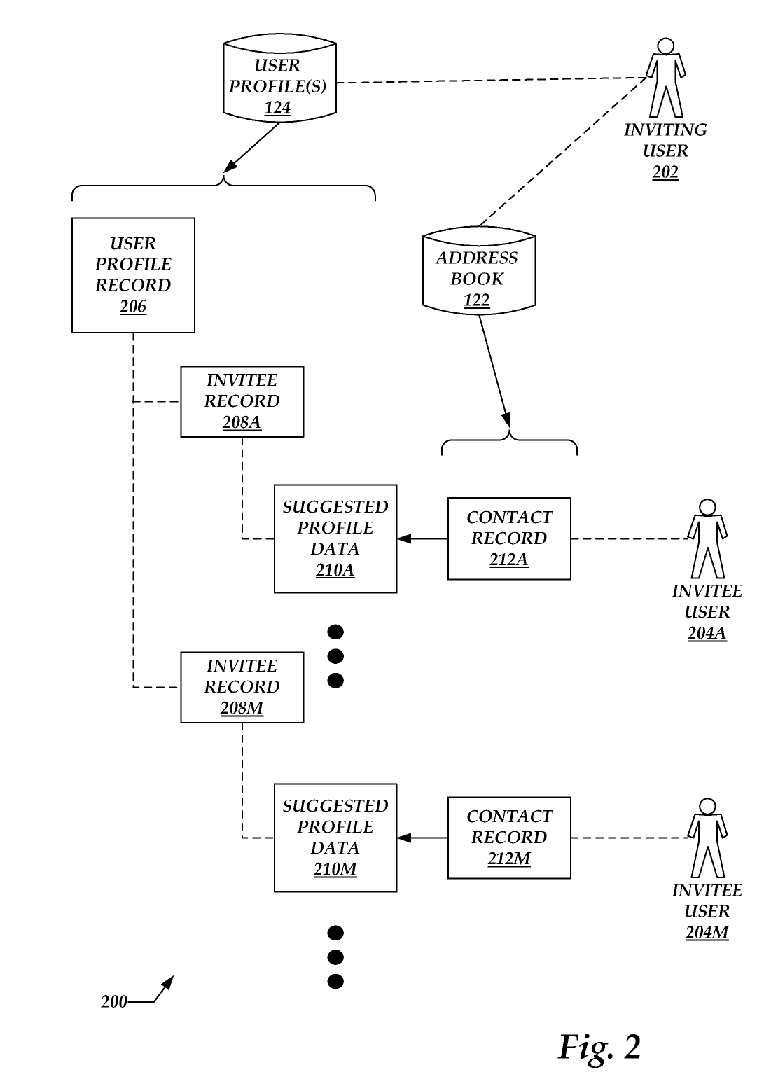

FIG. 2 illustrates examples of data structures or hierarchies, denoted generally at 200, that may be suitable for implementing the user profiles 124 shown in FIG. 1. For the purposes of this description, FIG. 2 is discussed from the perspective of user profile information maintained for a given user 202. However, it is understood that implementations of this description may include user profile information for any number of users. In addition, this description discusses examples in which the given user 202 is inviting one or more other users 204a and 204m (collectively, other users 204) to, for example, join a social network.

Turning to the user profiles 124 in more detail, a user profile record 206 may be associated with the inviting user 202. The user profile record 206 may contain or be associated with any number of invitee records 208a and 208m (collectively, invitee records 208). These invitee records 208a and 208m represent and correspond to invitations extended, respectively, to the users 204a and 204m. Because the users 204 are referred to as “invitee” users in this description, the records 208 are referred to as “invitee” records.

The invitee records 208 may respectively contain profile data 210a and 210m (collectively, profile data 210) that is associated with the invitee users 204a and 204m. more specifically, the profile suggestion software 120 may pre-populate the profile data 210a and 210m based upon information contained within the address book structure 122 associated with the inviting user 202. More specifically, the address book structure 122 may include a contact record 212a containing contact information for the invitee user 204a, and may include a contact record 212m containing contact information for the invitee user 204m. Examples of this contact information as contained in the contact records 212a and 212m (collectively, contact records 212) may include any information that may be stored in an address book or contact list. More specific examples of this contact information may include, but are not limited to, names, e-mail addresses, telephone numbers, usernames associated with messaging services, birthdays, identification of third-party services or websites of interest to those given users, areas of interest, and the like.

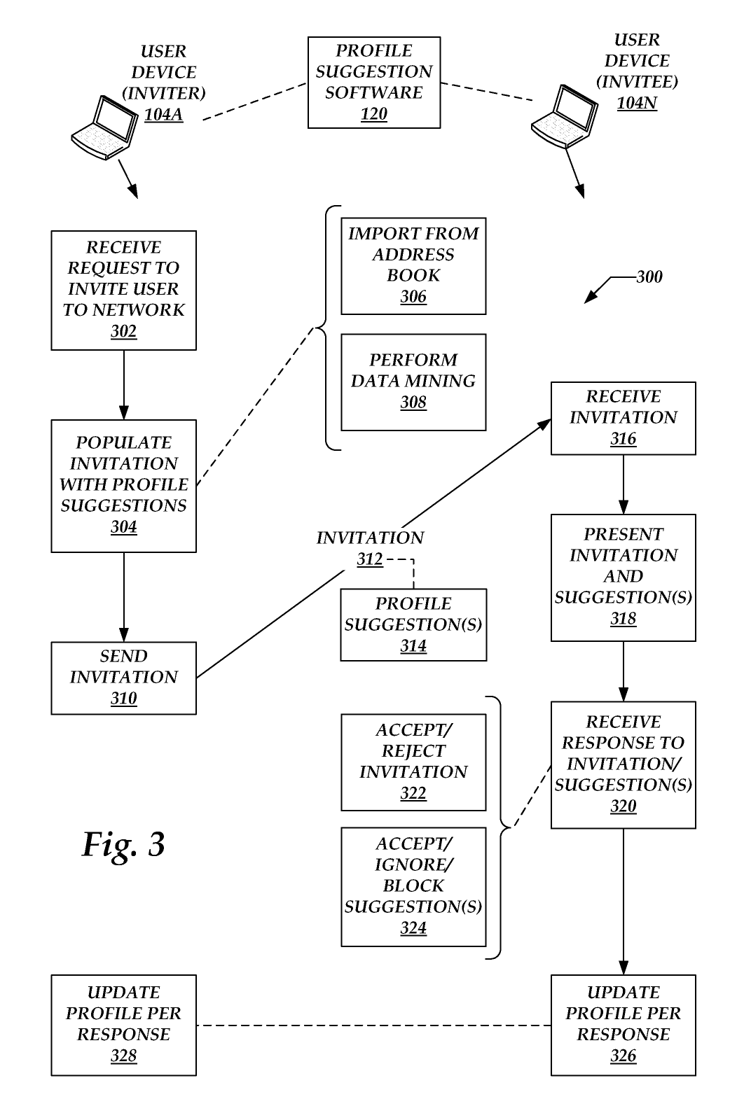

FIG. 3 illustrates process flows, denoted generally at 300, related to providing social network invitations with pre-populated profile information. For ease of description, but not to limit possible implementations of this description, the process flows 300 are described in connection with the profile suggestion software 120. In some implementations, the profile management system 102 may operate the profile suggestion software 120 on behalf of representative user devices (e.g., 104a and 104n) associated with inviter users and invitee users. In other implementations, the user devices 104a and 104n may themselves execute the profile suggestion software 120.

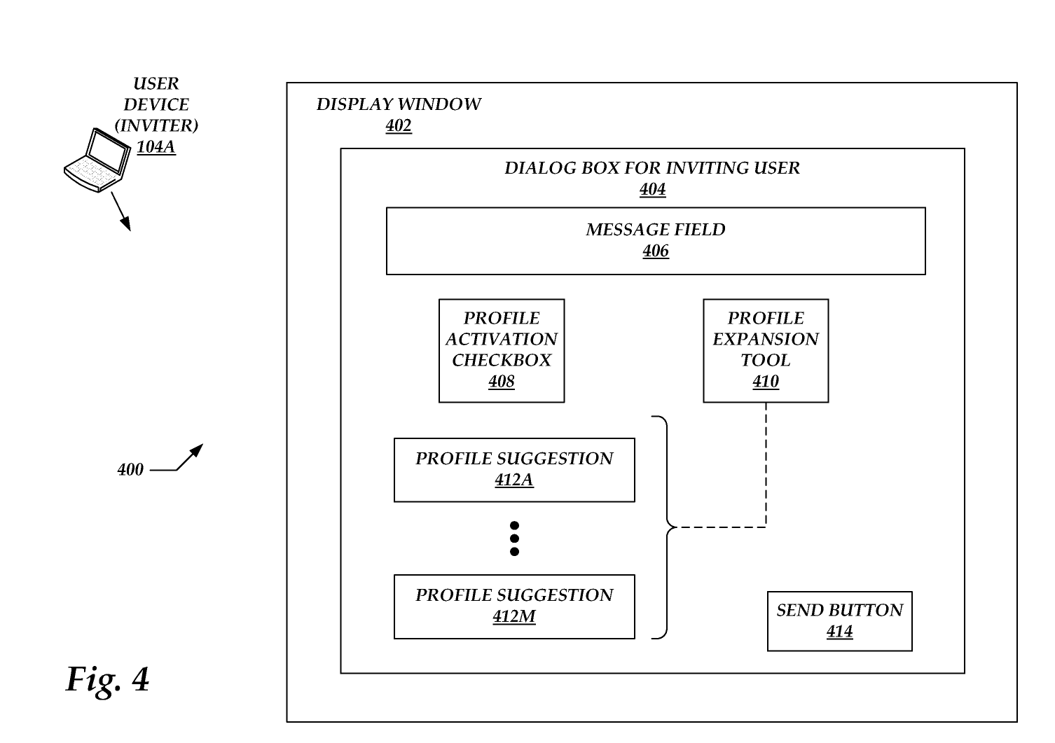

Turning to the process flows 300 more detail, block 302 represents receiving a request from a given user to invite one or more other users to join a given social network. In different implementation scenarios, this given user may or may not already be a member of the given social network. For example, the given user may invite the other user to be a “friend” of the given user on that given social network. Example user interfaces suitable for requesting and completing these invitations are illustrated and described with FIG. 4 below.

Block 304 represents populating the invitation requested in block 302 with profile information for the invited or invitee users. The invitation may be “pre-populated”, in the sense that the invitation may be at least partially completed with profile information when the invitee users receive it. For example, as represented at block 306, block 304 may include pre-populating the invitation with information extracted from an address book or contact list (e.g., 122 in FIGS. 1 and 2) associated with the inviting user (e.g., 202 in FIG. 2). The process flows 300 may perform block 306 in cases where the address book or contact list contains suitable information for the invitee or invited users (e.g., 204a and 204m in FIG. 2).

As represented at block 308, block 304 may include pre-populating the invitation with profile information resulting from data mining operations. In different implementation scenarios, the process flows 300 may perform block 308 in addition to, or instead of, block 306. Examples of the data mining operations may include obtaining publicly-available information relating to the invitee users, whether from the Internet or from other data sources. These data mining operations may also include analyzing e-mail or other communications sent or received by the invitee users. Other examples of data mining operations are possible as well, with the foregoing examples provided only for illustration.

Block 310 represents sending the invitation. FIG. 3 provides an example of an invitation at 312. In turn, this invitation 312 may include profile suggestions 314, pre-populated as represented by block 304.

As suggested by the arrangement of blocks 302-310 in columns, the user device 104a may perform the processing represented by blocks 302-310. As understood from the foregoing description, the user device 104a may repeat blocks 302-310 any number of times to send respective invitations 312 to any number of invitees. Having received at least one of the invitations 312, the user device 104n may perform further example processing, as now described in more detail.

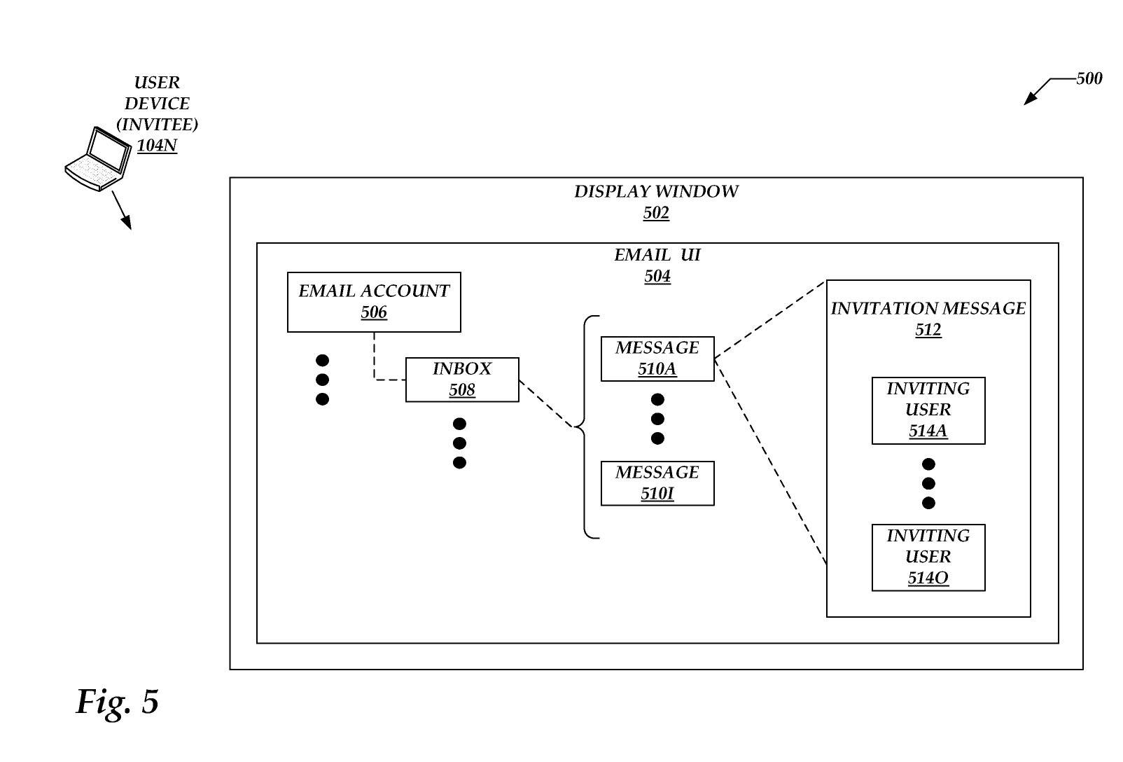

Block 316 represents receiving the invitation 312. In example shown in FIG. 3, the user device 104n may receive invitation 312 from one or more user devices 104a. In turn, block 318 represents presenting the invitation 312 and any profile suggestions 314 on the invitee's user device 104n. Examples of user interfaces suitable for receiving and presenting the invitations are described below with FIG. 5.

Block 320 represents receiving one or more user responses to the invitation and/or the profile suggestions presented in block 318. In some possible implementation scenarios, the profile suggestion software 120 may handle the invitation and any related profile suggestions as one discrete unit. In other implementation scenarios, the profile suggestion software 120 may handle the invitation and any related profile suggestions separately from one another.

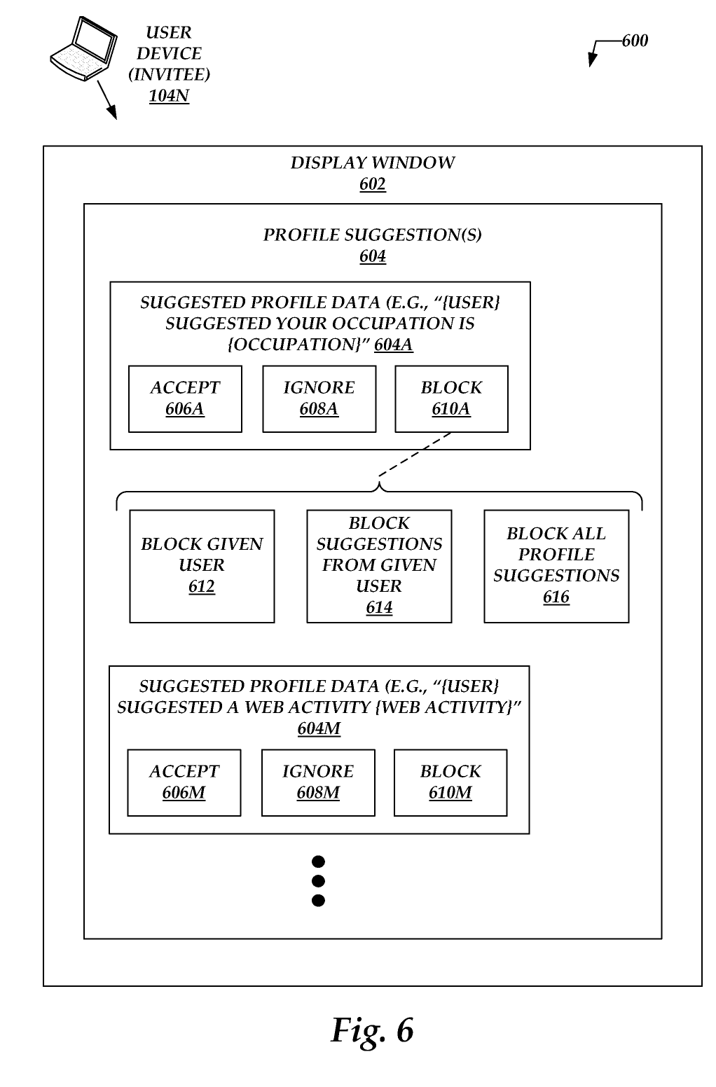

In more detail, block 320 may include receiving indications that the invitee user has accepted or rejected the invitation as a whole, as represented by block 322. Block 320 may also include receiving indications that the invitee user has taken particular actions regarding the pre-populated profile suggestions 314 included with the invitation 312, as represented by block 324. For example, the invitee user may accept, ignore, block, or take other actions regarding the pre-populated profile suggestions 314. Examples of user interfaces suitable for presenting the pre-populated profile suggestions are described below in connection with FIG. 6.

Blocks 326 and 328, performed respectively on the invitee user device 104n and the inviter user device 104a, represent updating user profile information associated with the invitee user and the inviter user. More specifically, blocks 326 and 328 may include updating user profiles (e.g., 124 in FIG. 1) based upon the response of the invitee user to the invitation 312 and/or at the profile suggestions 314. For example, referring briefly back to FIG. 2, if the invitee user 204a accepts or approves the invitation 312, the corresponding invitee record 208a may be so updated. Likewise, if the invitee user 204m rejects the invitation 312, the corresponding invitee record 208m may be so updated.

In general, the invitee records 208 may reflect any number of states through which invitations may pass. From the perspective of the inviting user 202, the invitee records 208 may indicate that a given invitation is outbound to an invitee user 204, and is pending acceptance/approval or rejection. Once the invitee user 204 has acted on that given invitation, the invitee records 208 may indicate that that given invitation 312 has been accepted or rejected.

From the perspective of the invitee user 204a or 204m, the invitee records 208 may indicate that a given invitation 312 is inbound from one or more inviting users 202. Likewise, once the invitee user 204 has acted on the invitation 312, the invitee records 208 may indicate that that given invitation 312 has been accepted or rejected. In addition, the invitee records 208 may indicate that the invitee user 204 has accepted, ignored, or block certain suggested profile data included with the given invitation 312.

FIG. 4 illustrates user interfaces (UIs), denoted generally at 400, that may enable the user devices 104a to create and send social network invitations with pre-populated profile information. Turning to the user interfaces 400 and more detail, a display window 402 may appear on display hardware provided by the user device 104a. For example, the profile suggestion software 120 may create and populate the display window 402 in response to user commands.

A dialog box 404 may provide various UI tools and devices by which an inviter user may employ the user device 104a to create and populate the invitations 312. For example, the inviter user may type or enter a greeting or message into a message field 406. This greeting or message may be tailored for different particular invitee users.

If the inviter user wishes to invoke the capability is described herein to pre-populate the invitation 312 with suggested profile information, the inviter user may select a profile activation checkbox 408. In response to the user selecting the profile activation checkbox 408, the profile suggestion software 120 may enable a profile expansion tool 410. The profile expansion tool 410 may respond to user input to present any number of profile suggestion tools 412a and 412m (collectively, profile suggestion tools 412). The profile suggestion software 120 may populate the profile suggestion tools 412 using any of the techniques described herein. For example, the profile suggestion tools 412 may be populated with information extracted from a contact list or address book, information resulting from data mining operations, or the like.

The profile suggestion tools 412 may suggest profile information including, but not limited to: contact information associated with a given invitee user (e.g., mobile telephone numbers, e-mail addresses, and the like), personal information associated with the invitee user (e.g., birthdays, anniversaries, names of spouses, and the like), observations or notes associated with the invitee (e.g., good or bad poker player, and the like), and the like.

The profile information populated by the profile suggestion tools 412 may also include indications of any third-party services or activity streams associated with the invitee user. Examples of such third-party services may include, but are not limited to, social networking sites, image or media sharing sites, and the like. Examples of activity streams may include “wish list” associated with online merchants, indications of websites of interest to the invitee user, and the like.

The inviter user may interact with any of the suggested profile information provided by the profile suggestion tools 412, typically either approving or disapproving the suggested profile information. Once the profile suggestion tools 412 are in an acceptable state, the inviter user may activate a send button 414 to send the invitation 312 to the invitee user.

It is noted that the user interfaces 400 may be presented any number of times to any number of inviter users, thereby enabling the inviter users to create social network invitations with pre-populated profile information, and to send the social network invitations to the invitee users. User interfaces suitable for presenting the invitations to the invitee users are now described with FIG. 5.

FIG. 5 illustrates user interfaces, denoted generally at 500, that may be presented by the invitee user devices 104n to display any number of invitations 312 to join social networks. The user interfaces 500 are described in connection with invitations 312 transmitted by e-mail. However, implementations of this description may transmit the invitations 312 by means other than e-mail, without departing from the scope and spirit of this description.

A display window 502 may be presented on display hardware provided by the invitee user device 104n. In turn, the display window 502 may present an e-mail user interface 504 associated with an e-mail utility. In turn, the e-mail user interface 504 may include representations 506 of any number of e-mail accounts associated with an invitee user. The representations 506 may include depictions of any number of folders associated with the e-mail accounts, including an inbox representation 508. The inbox represented at 508 may include any number of incoming messages 510a and 510i (collectively, incoming messages 510). In the example shown in FIG. 5, the incoming message 510a corresponds to the invitation 312 sent previously by the inviter user. FIG. 5 represents at 512 the invitation 312 as encoded into the incoming message 510a.

Turning to the invitation message 512 in detail, the invitation message 512 may include a greeting from the inviter user. In scenarios in which a given invitee has received multiple invitations from multiple inviter users to join a social network, the invitation message 512 may include representations 514a and 514o (collectively, representations 514) of those other inviter users. In these scenarios, the invitee may be reassured by seeing representations of persons that he or she knows, and may be more favorably disposed to accept or approve the invitation.

Having received the invitation message 512, if the invitee user is not interested in joining the social network, invitee user may reject invitation or ignore the invitation and not act on it. However, if the invitee user is interested in accepting or approving the invitation and joining the social network, the invitee user may select and interact with the invitation message 512.

FIG. 6 illustrates user interfaces, denoted generally at 600, that the invitee user devices 104n may present to enable invitee users to act on invitations 312 to join social networks. A display window 602 may be presented on display hardware provided by the user device 104n. In turn, the profile suggestion software 120 may present profile suggestions 604 within the display window 602. These profile suggestions 604 may correspond to the profile suggestions populated as shown at 412 in FIG. 4. For example, a first profile suggestion 604a may indicate that the inviter user suggested a particular occupation for the invitee user, while another profile suggestion 604m may indicate that the inviter user has suggested a Web activity for the invitee user. In other examples, the profile suggestions 604 may indicate birthdays, phone numbers, e-mail addresses, or other suitable profile information for invitees.

In general, the profile suggestions 604 may correspond to the pre-populated profile suggestions 314 shown in FIG. 3. Having been presented with any number of the profile suggestions 604, the invitee user may act on these profile suggestions 604 as facilitated by the UIs 600. For example, referring to the profile suggestions 604a and 604m specifically, the UIs 600 may include respective accept buttons 606a and 606m (collectively, accept buttons 606), ignore buttons 608a and 608m (collectively, ignore buttons 608), and block buttons 610a and 610m (collectively, block buttons 610).

The UIs 600 may respond to user activation of the accept buttons 606 to accept or approve the profile suggestions 604 that correspond to the activated accept buttons 606. Similarly, the UIs 600 may respond to user activation of the ignore buttons 608 to reject the profile suggestions that correspond to the activated ignore buttons 608.

The UIs 600 may respond to user activation of the block buttons 610 to present additional UI tools that provide additional granularity on block functions. For example, if the invitee user activates the block button 610a, the UIs 600 may present additional block buttons 612, 614, and 616. The block button 612 may respond to user activation to block all communications (i.e., invitations and profile suggestions) received from a given inviter user who sent the current invitation. The block button 614 may respond to user activation to block all profile suggestions from the given inviter user. The block button 616 may respond to user activation to block all profile suggestions from all users.

Having described the tools and techniques for creating and sending social network invitations with pre-populated profile information in connection with FIGS. 1-6, several observations are noted. As described above, at least some of the invitations may be pre-populated with profile information before the invitations are sent to invitees. The invitee users may be more favorably disposed to accept the invitations and accept the profile information, because the profile suggestion software 120 has performed at least some of the work involved with populating the profile information on behalf of the inviter an invitee users. Accordingly, social networks or other networks that implement at least portions of the profile suggestion software 120 may experience increased rates of acceptance for invitations to join the networks.

The foregoing description provides tools and techniques for social network invitations with pre-populated profile information. Although this description incorporates language specific to computer structural features, methodological acts, and computer readable media, the scope of the appended claims is not necessarily limited to the specific features, acts, or media described herein. Rather, this description provides illustrative, rather than limiting, implementations. Moreover, these implementations may modify and change various aspects of this description without departing from the true spirit and scope of this description, which is set forth in the following claims.

We claim:

1. Apparatus comprising at least one physical computer-readable storage medium having stored thereon computer-executable instructions that, when loaded into at least one hardware processor and executed, transform the hardware processor to perform the following:
receive at least one request to create an invitation for least one user to join a social network associated with at least a further user;
populate the invitation with profile information provided on behalf of the further user; and
send the invitation to the user.

2. The apparatus of claim 1, wherein the instructions to populate the invitation include instructions that transform the hardware processor to populate the invitation with contact information extracted from an address book record maintained by the further user, wherein the address book record contains information relating to the user.

3. The apparatus of claim 1, wherein the instructions to populate the invitation include instructions that transform the hardware processor to populate the invitation with information resulting from data mining activities.

4. The apparatus of claim 1, wherein the instructions to populate the invitation include instructions that transform the hardware processor to populate the invitation with contact information associated with the further user.

5. The apparatus of claim 1, wherein the instructions to populate the invitation include instructions that transform the hardware processor to populate the invitation with personal information associated with the further user.

6. The apparatus of claim 1, wherein the instructions to populate the invitation include instructions that transform the hardware processor to populate the invitation with information representing web activity associated with the further user.

7. The apparatus of claim 1, further comprising instructions that transform the hardware processor to receive approval or rejection of the profile information.

8. Apparatus comprising at least one physical computer-readable storage medium having stored thereon computer-executable instructions that, when loaded into at least one hardware processor and executed, transform the hardware processor to perform the following:
receive at least one invitation for a user to join a social network associated with at least a further user;
present a visual representation of pre-populated profile information for the user that is included in the invitation; and
present at least one user interface (UI) tool that is responsive to activation by the user to act on the profile information.

9. The apparatus of claim 8, wherein the instructions to present at least one UI tool include instructions that transform the hardware processor to present a button responsive to activation from the user to accept at least one instance of the profile information.

10. The apparatus of claim 8, wherein the instructions to present at least one UI tool include instructions that transform the hardware processor to present a button responsive to activation from the user to reject at least one instance of the profile information.

11. The apparatus of claim 8, wherein the instructions to present at least one UI tool include instructions that transform the hardware processor to present a button responsive to activation from the user to block profile information or invitations from at least a further user.

12. The apparatus of claim 8, wherein the instructions to present at least one UI tool include instructions that transform the hardware processor to present a button responsive to activation from the user to block profile information suggested by at least a particular further user.

13. The apparatus of claim 8, wherein the instructions to present at least one UI tool include instructions that transform the hardware processor to present a button responsive to activation from the user to block profile information suggested by at least a plurality of further users.

14. The apparatus of claim 8, wherein the instructions to present a visual representation of pre-populated profile information for the user include instructions that transform the hardware processor to present representations of contact information relating to the user, as provided on behalf of at least one further user.

15. The apparatus of claim 8, wherein the instructions to present a visual representation of pre-populated profile information for the user include instructions that transform the hardware processor to present representations of personal information relating to the user, as provided on behalf of at least one further user.

16. The apparatus of claim 8, wherein the instructions to present a visual representation of pre-populated profile information for the user include instructions that transform the hardware processor to present representations of profile information extracted from an address book associated with at least one further user.

17. The apparatus of claim 8, wherein the instructions to present a visual representation of pre-populated profile information for the user include instructions that transform the hardware processor to present representations of profile information resulting from data mining techniques.

18. The apparatus of claim 8, wherein the instructions to receive at least one invitation include instructions that transform the hardware processor to receive an invitation sent on behalf of the further user.

19. Apparatus comprising at least one physical computer-readable storage medium having stored thereon computer-executable instructions that, when loaded into at least one hardware processor and executed, transform the hardware processor to perform the following:
receive a request from at least a first user to create at least one invitation for least a second user to join a social network associated with the first user;
populate the invitation with suggested profile information provided on behalf of the first user, wherein the suggested profile information is extracted from a contact list associated with the first user, and wherein the contact list contains contact information for least the second user;
send the invitation to the second user on behalf of the first user;
present to the second user a visual representation of the suggested profile information for the user as pre-populated in the invitation; and
present at least one user interface (UI) tool that is responsive to activation by the user to act on the suggested profile information.

20. The apparatus of claim 19, wherein the instructions to present at least one UI tool instructions that transform the hardware processor to present at least one instance of an accept button, an ignore button, and a block button, wherein the accept button, the ignore button, and the block button are associated with a corresponding instance of the suggested profile information, and wherein:
the accept button is responsive to user activation to accept the instance of suggested profile information;
the ignore button is responsive to user activation to reject the instance of suggested profile information;
the block button is responsive to user activation to block the instance of suggested profile information, or to block indications from the first user.
